(19) United States
(12) Patent Application Publication
(10) Pub. No.: US 2016/0165041 A1
(43) Pub. Date: Jun. 9, 2016

(54) INCOMING CALL SWITCHING METHOD AND COMMUNICATIONS TERMINAL

(71) Applicant: DONGGUAN GOLDEX COMMUNICATION TECHNOLOGY CO., LTD., Dongguan (CN)

(72) Inventor: Sanxin WANG, Dongguan (CN)

(73) Assignee: DONGGUAN GOLDEX COMMUNICATION TECHNOLOGY CO., LTD., Dongguan (CN)

(21) Appl. No.: 15/042,411

(22) Filed: Feb. 12, 2016

Related U.S. Application Data
(63) Continuation of application No. PCT/CN2014/070805, filed on Jan. 17, 2014.

(30) Foreign Application Priority Data
Aug. 12, 2013 (CN) 201310350051.2

(51) Int. Cl. H04M 1/73; H04W 4/02; H04W 52/02; H04M 7/12

(52) U.S. Cl. CPC H04M 1/73; H04M 7/1205; H04W 4/027; H04W 52/0254; H04W 88/06

(57) ABSTRACT

Embodiments of the present invention relate to the technical field of communication, and disclose an incoming call switching method and a communication terminal. The method comprises: detecting whether a communication terminal is in a used state or mobile state; and if the communication terminal is in the used state or mobile state, sending a control instruction to a bound terminal of the communication terminal, so as to switch an incoming call or message of the bound terminal to the communication terminal. By means of the embodiment of the present invention, an incoming call may be timely switched and the waiting time for switching the incoming call may be shortened.

### CROSS REFERENCE TO RELATED APPLICATIONS

This application is a continuing application of PCT Patent Application No. PCT/CN2014/070805, entitled “INCOMING CALL SWITCHING METHOD AND COMMUNICATIONS TERMINAL”, filed on Jan. 17, 2014, which claims priority to Chinese Patent Application No. 201310350051.2, filed on Aug. 12, 2013, both of which are hereby incorporated in its entirety by reference.

### TECHNICAL FIELD

The present invention relates to the technical field of communication, and in particular, relates to an incoming call switching method and a communication terminal.

### BACKGROUND

Incoming call switching and message switching in the field of communication is an important function, especially for business people. When a mobile phone is forgotten to bring, business loss due to communication may be reduced by switching a business incoming call to a designated phone. Prior incoming call switching methods are mainly of the following types: the first type is that an user switches an incoming call of the user's mobile phone to a designated phone by a network server, for example, ringing customer service and setting a designated number by the customer service; the second type is that the user remotely controls the mobile phone to set incoming call switching function, such that the phone adjusts the incoming call to be switched to the designated phone after receiving a message of specific format. Furthermore, currently operators have another type of service, i.e. binding multiple mobile phones together, and then switching to the designated phone in turn.

The several above methods may help a caller to communicate with a user to some extent, but according to the first or second type of method, it is necessary for the user to make settings initiatively, so there will be a gap of a certain time, that is to say, an incoming call before the user makes settings cannot be immediately switched; the automatic binding method according to the third type often requires the caller to wait for a long time, which will affect the user's experience.

### SUMMARY

The embodiments of the present invention disclose an incoming call switching method and a communication terminal which can timely switch an incoming call and shorten the waiting time for switching the incoming call.

The first aspect of the embodiments of the present invention provides an incoming call switching method comprising: detecting whether a communication terminal is in a used state or mobile state; and sending a control instruction to a bound terminal of the communication terminal so as to switch an incoming call or message of the bound terminal to the communication terminal, if the communication terminal is in the used state or mobile state.

The second aspect of the embodiments of the present invention provides a communication terminal comprising: a detecting unit for detecting whether the communication terminal is in a used state or mobile state; and a first switching unit for, when the detecting unit detects the communication terminal being in the used state or mobile state, sending a control instruction to a bound terminal of the communication terminal so as to switch an incoming call or message of the bound terminal to the communication terminal.

According to the embodiments of the present invention, an incoming call may be timely switched and the waiting time for switching the incoming call may be shortened, by detecting whether a communication terminal is in a used state or mobile state, and sending a control instruction to a bound terminal of the communication terminal so as to switch an incoming call or message of the bound terminal to the communication terminal when the communication terminal is detected being in the used state or mobile state.

### BRIEF DESCRIPTION OF THE DRAWINGS

In order to more clearly describe technical solutions according to the embodiments of the present invention, the accompanying drawings used for the embodiments will be briefly introduced hereinafter. Apparently, the accompanying drawings described hereinafter show some embodiments of the present invention, and persons skilled in the art may also derive other drawings from these accompanying drawings without creative efforts.

FIG. 1 is a flowchart of an incoming call switching method according to an embodiment of the present invention;

FIG. 2 is a flowchart of another incoming call switching method according to an embodiment of the present invention;

FIG. 3 is a schematic structural diagram of a communication terminal according to an embodiment of the present invention;

FIG. 4 is a schematic structural diagram of another communication terminal according to an embodiment of the present invention;

FIG. 5 is a schematic structural diagram of an incoming call switching system according to an embodiment of the present invention.

FIG. 6 is a schematic structural diagram of a communication terminal according to an embodiment of the present invention.

### DETAILED DESCRIPTION

In conjunction with the drawings in the embodiments of the present invention, a clear, complete description for the technical solutions in the embodiments of the present invention is provided below. Apparently, the described embodiments are a part rather than all of the embodiments of the present invention. All other embodiments obtained by persons skilled in the art based on the embodiments of the present invention without creative efforts should fall within the protection scope of the present invention.

The embodiments of the present invention disclose an incoming call switching method and a communication terminal which can timely switch an incoming call and shorten the waiting time for switching the incoming call. A detailed description is provided hereinafter.

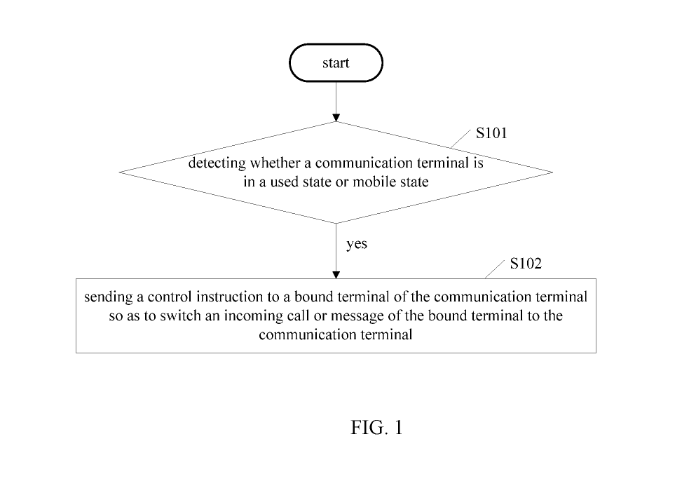

Referring to FIG. 1, it shows a flowchart of an incoming call switching method according to an embodiment of the present invention. As shown in FIG. 1, the incoming call switching method may include the following steps.

Step S101 is detecting whether a communication terminal is in a used state or mobile state.

Specifically, it may be judged whether the communication terminal is being used by detecting whether an operation instruction given by a user to the communication terminal is received. For example, when operations such as tapping on the screen, waking up the screen, accessing network etc. occurs on the communication terminal, it may be determined that the communication terminal is in the used state. Moreover, it may be judged whether the communication terminal is in the mobile state with a gravity accelerometer or GPS. For example, when the gravity accelerometer or GPS detects the position state of the communication terminal being always changing, it may be determined that the communication terminal is in the mobile state, on the contrary, it may be determined that the communication terminal is stationary, and is maybe forgotten somewhere. Of course, the mobile state of the communication terminal may also be detected with other sensors or positioning devices which can measure the mobile state. It is to be noted that the purpose of performing the step 5101 is to detect whether the communication terminal is by the user's side. It may also be detected whether the communication terminal is by the user's side by methods other than judging the used state or mobile state, for example, detecting whether the communication terminal touches the user with a touch sensor on the communication terminal (when the user sits stationarily with the communication terminal in a trousers pocket).

Step S102 is sending a control instruction to a bound terminal of the communication terminal so as to switch an incoming call or message of the bound terminal to the communication terminal.

Specifically, when the communication terminal is detected being in the used state or mobile state, an incoming call or message of other communication terminals which are bound to the communication terminal and are not in the used state or mobile state are switched to the communication terminal. The specific implementing manner may be that, for example, the communication terminal sends an incoming call switching control instruction to the other communication terminals which are bound to the communication terminal and are not in the used state or mobile state, such that the other communication terminals which are bound to the communication terminal and are not in the used state or mobile state switch the incoming call or message to the communication terminal. In addition, the incoming call switching control instruction may be a message of specific format.

In the incoming call switching method provided in FIG. 1, an incoming call may be timely switched and the waiting time for switching the incoming call may be shortened, by detecting whether the communication terminal is in the used state or mobile state and switching the incoming call or message of the bound terminal of the communication terminal to the communication terminal when the communication terminal is detected being in the used state or mobile state.

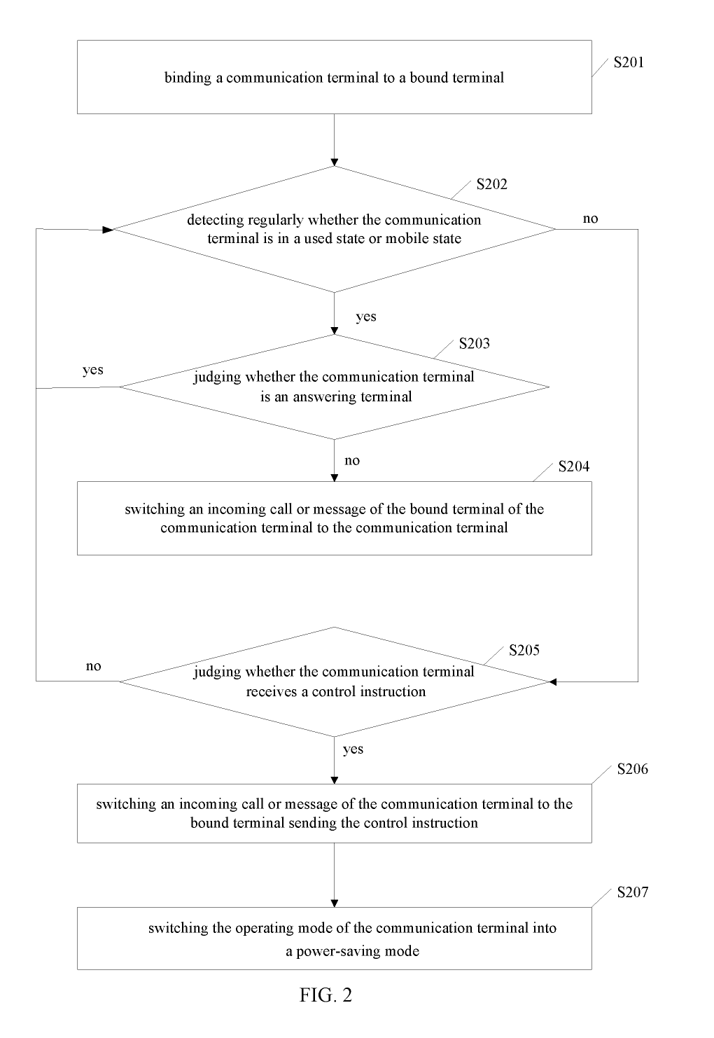

Referring to FIG. 2, it shows a flowchart of another incoming call switching method according to an embodiment of the present invention. As shown in FIG. 1, the incoming call switching method may include the following steps.

Step S201 is binding a communication terminal to a bound terminal.

Specifically, the communication terminal may be a mobile terminal or fixed-line phone. The communication terminal may be bound to communication numbers of other communication terminals. The communication numbers may be, for example, SIM card numbers.

Step S202 is detecting regularly whether the communication terminal is in a used state or mobile state.

Specifically, it is detected at time intervals whether the communication terminal is in the used state or mobile state. The time interval may depend on specific situations, for example, it may be one hour, half a day and so on. When the communication terminal is detected being in the used state or mobile state, the process goes to step S203; when the communication terminal is detected being not in the used state or mobile state, the process goes to step S205.

Step S203 is judging whether the communication terminal is an answering terminal.

Specifically, it is judged whether the communication terminal is the answering terminal to which other communication terminals bound to the communication terminal and not in the used state or mobile state switch an incoming call or message. If so, the process goes to the step S202 to continue to monitor whether the state of the communication terminal is changed; if not, the process goes to the step S204.

Step S204 is switching the incoming call or message of the bound terminal of the communication terminal to the communication terminal;

Specifically, the incoming call or message of the other communication terminals bound to the communication terminal and not in the used state or mobile state may be switched to the communication terminal which may send an incoming call switching control instruction to the other communication terminals bound to the communication terminal and in the used state or mobile state, such that the other communication terminals bound to the communication terminal and not in the used state or mobile state switch the incoming call or message to the communication terminal, and the communication terminal is designated as the answering terminal. In addition, the incoming call switching control instruction may be a message of specific format.

Step S205 is judging whether the communication terminal receives the control instruction.

Specifically, when the communication terminal is detected being not in the used state or mobile state, it may be judged firstly whether the communication terminal receives the incoming call switching control instruction sent by the bound terminal of the communication terminal. If not (it means that the communication terminal has switched the incoming call to the bound terminal), the process goes to the step S202 to continue to monitor whether the state of the communication terminal is changed; if so, the process goes to the step S206.

Step S206 is switching the incoming call or message of the communication terminal to the bound terminal sending the control instruction.

Specifically, when the communication terminal is detected being not in the used state or mobile state, the communication terminal may receive the incoming call switching control instruction sent by the bound terminal bound to the communication terminal and in the used state or mobile state, so as to switch the incoming call or message of the communication terminal to the bound terminal sending the control instruction and designate the communication terminal as a switching terminal. Of course, in another embodiment, the communication terminal may also initiatively switch the incoming call or message to the other communication terminals bound to the communication terminal and in the used state or mobile state.

Step S207 is switching the operating mode of the communication terminal into a power-saving mode.

Specifically, the power-saving mode may include, for example, extending scanning cycles of radio unit, closing background programs running in the terminal, switching terminal system into non-smart mode, etc., that is to say, only functions of receiving the control instruction and detecting whether the terminal is in the used state or mobile state may be retained.

In the incoming call switching method provided in FIG. 2, an incoming call may be timely switched and the waiting time for switching the incoming call may be shortened, by binding several communication terminals together, detecting regularly whether the communication terminal is in the used state or mobile state, and when the communication terminal is detected being in the used state or mobile state, switching the incoming call or message of the other communication terminals bound to the communication terminal and not in the used state or mobile state to the communication terminal, and furthermore, when the communication terminal is detected being not in the used state or mobile state, switching the incoming call or message of the communication terminal to the bound terminal bound to the communication terminal and in the used state or mobile state.

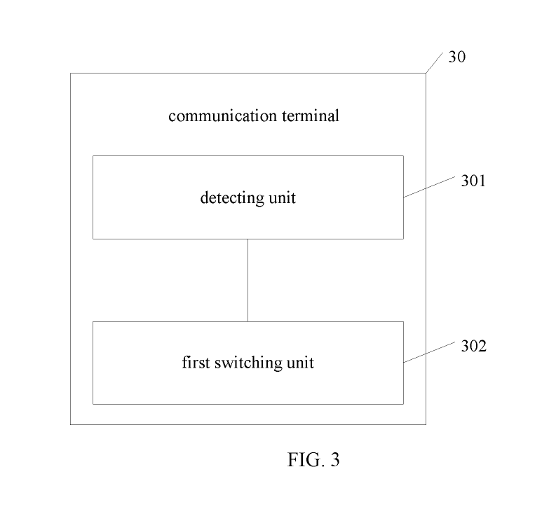

Referring to FIG. 3, it shows a schematic structural diagram of a communication terminal according to an embodiment of the present invention. A communication terminal 30 may be, for example, a mobile terminal or a fixed-line phone. As shown in FIG. 3, the communication terminal 30 may include a detecting unit 301 and a first switching unit 302.

The detecting unit 301 is for detecting whether the communication terminal 30 is in a used state or mobile state. Specifically, it may be judged whether the communication terminal 30 is being used by detecting whether an operation instruction given by a user to the communication terminal 30 is received. For example, when operations such as tapping on the screen, waking up the screen, accessing network etc. occurs on the communication terminal 30, it may be determined that the communication terminal 30 is in the used state. Moreover, it may be judged whether the communication terminal 30 is in the mobile state with a gravity accelerometer or GPS. For example, when the gravity accelerometer or GPS detects the position state of the communication terminal 30 being always changing, it may be determined that the communication terminal 30 is in the mobile state, on the contrary, it may be determined that the communication terminal 30 is stationary, and is maybe forgotten somewhere. Of course, the mobile state of the communication terminal 30 may also be detected with other sensors or positioning devices which can measure the mobile state. It is to be noted that the purpose of detecting whether the communication terminal 30 is in a used state or mobile state is to detect whether the communication terminal 30 is by the user's side. It may also be detected whether the communication terminal 30 is by the user's side by methods other than judging the used state or mobile state, for example, detecting whether the communication terminal touches the user with a touch sensor on the communication terminal (when the user sits stationarily with the communication terminal in a trousers pocket).

The first switching unit 302 is for, when the detecting unit 301 detects the communication terminal 30 being in the used state or mobile state, sending a control instruction to a bound terminal of the communication terminal 30 so as to switch an incoming call or message of the bound terminal to the communication terminal 30. Specifically, the communication terminal 30 may send a message of an incoming call switching control instruction to the other communication terminals which are bound to the communication terminal 30 and are not in the used state or mobile state, such that the other communication terminals which are bound to the communication terminal 30 and are not in the used state or mobile state switch an incoming call or message to the communication terminal 30. In addition, the incoming call switching control instruction may be a message of specific format.

The communication terminal provided in FIG. 3 may timely switch an incoming call and shorten the waiting time for switching the incoming call, by detecting whether being in the used state or mobile state and switching the incoming call or message of the bound terminal of the communication terminal to the communication terminal when being detected being in the used state or mobile state,.

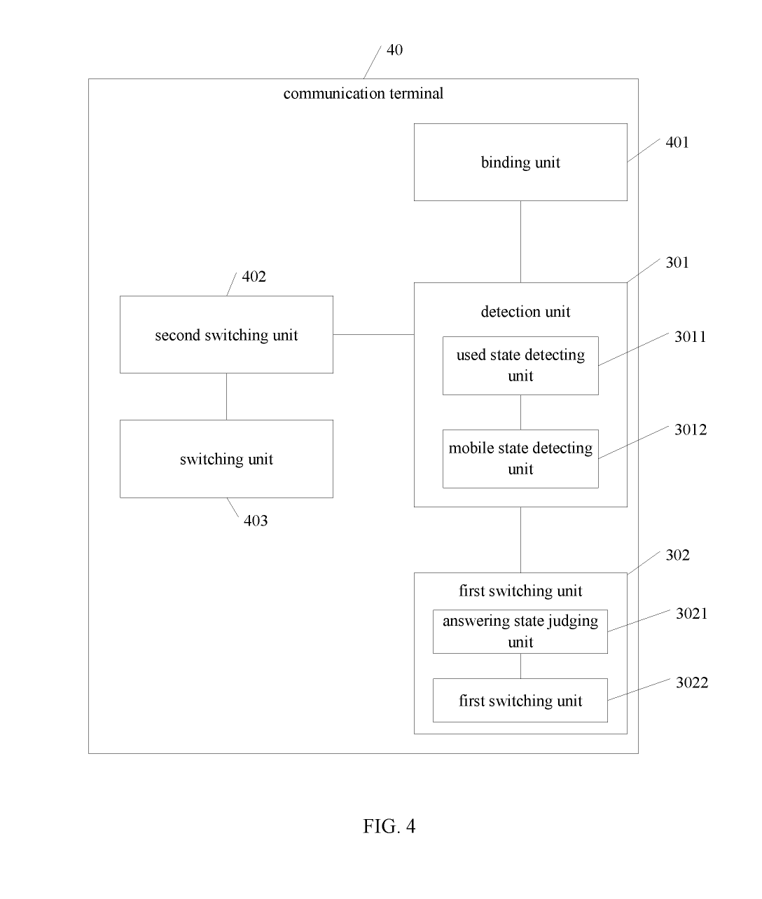

Referring to FIG. 4, it shows a schematic structural diagram of another communication terminal according to an embodiment of the present invention. A communication terminal 40 as shown in FIG. 4 is obtained by optimizing the communication terminal 30 as shown in FIG. 3. The communication terminal 40 as shown in FIG. 4, further includes a binding unit 401, a second switching unit 402 and a switching unit 403, and the detection unit 301 specifically includes a used state detecting unit 3011 and a mobile state detecting unit 3012, and the first switching unit 302 specifically includes a answering state judging unit 3021 and a first switching unit 3022.

The binding unit 401 is for binding the communication terminal 40 to a bound terminal before the detection unit 301 detects whether the communication terminal 40 is in a used state or mobile state. Specifically, the communication terminal 40 may be bound to communication numbers of other communication terminals. The communication numbers may be, for example, SIM card numbers.

The second switching unit 402 is for judging whether the control instruction sent by the bound terminal in the used state or mobile state is received, when the detection unit 301 detects the communication terminal 40 being not in the used state or mobile state. If so, an incoming call or message of the communication terminal 40 is switched to the bound terminal sending the control instruction and the communication terminal 40 is designated as a switching terminal. Specifically, the communication terminal 40 may receive the incoming call switching control instruction sent by the bound terminal bound to the communication terminal 40 and in the used state or mobile state, so as to switch the incoming call or message of the communication terminal 40 to the bound terminal sending the control instruction and designate the communication terminal 40 as the switching terminal. Of course, in another embodiment, the communication terminal 40 may also initiatively switch the incoming call or message to the other communication terminals bound to the communication terminal and in the used state or mobile state.

The switching unit 403 is for switching the operating mode of the communication terminal 40 into a power-saving mode after the communication terminal 40 is designated as the switching terminal. Specifically, the power-saving mode may include, for example, extending scanning cycles of radio unit, closing background programs running in the terminal, switching terminal system into non-smart mode, etc., that is to say, only functions of receiving the control instruction and detecting whether the terminal is in the used state or mobile state may be retained.

Furthermore, the used state detecting unit 3011 of the detection unit 301 is for detecting whether an operation instruction given by a user to the communication terminal 40 is received, so as to judge whether the communication terminal 40 is in the used state. For example, when operations such as tapping on the screen, waking up the screen, accessing network etc. occurs on the communication terminal 40, it may be determined that the communication terminal 40 is in the used state.

The mobile state detecting unit 3012 is for judging whether the communication terminal is in the mobile state with a gravity accelerometer or judging whether the communication terminal is in the mobile state with GPS. For example, when the gravity accelerometer or GPS detects the position state of the communication terminal 40 being always changing, it may be determined that the communication terminal 40 is in the mobile state, on the contrary, it may be determined that the communication terminal 40 is stationary, and is maybe forgotten somewhere. Of course, the mobile state of the communication terminal 40 may also be detected with other sensors or positioning devices which can measure the mobile state. It is to be noted that the purpose of detecting whether the communication terminal 40 is in a used state or mobile state is to detect whether the communication terminal 40 is by the user's side, and therefore the detection unit 301 may also include units for detecting whether the communication terminal 40 is by the user's side, which does not judge the used state or mobile state.

Furthermore, the answering state judging unit 3021 of the first switching unit 302 is for judging whether the communication terminal 40 is an answering terminal after the communication terminal 40 is detected being in the used state or mobile state. Specifically, the answering state judging unit 3021 may judge whether the communication terminal 30 is the answering terminal to which the other communication terminals bound to the communication terminal 40 and not in the used state or mobile state switch the incoming call or message.

The first switching unit 3022 is for sending the control instruction to the bound terminal of the communication terminal 40 when the answering state judging unit 3021 determines the communication terminal 40 is not the answering terminal, switching the incoming call or message of the bound terminal to the communication terminal 40, and designating the communication terminal 40 as the answering terminal. Specifically, the first switching unit 3022 may switch the incoming call or message of the other communication terminals bound to the communication terminal 40 and not in the used state or mobile state to the communication terminal 40 which may send the incoming call switching control instruction to the other communication terminals bound to the communication terminal 40 and in the used state or mobile state, such that the other communication terminals bound to the communication terminal 40 and not in the used state or mobile state switch the incoming call or message to the communication terminal 40, and the communication terminal 40 is designated as the answering terminal.

The communication terminal provided in FIG. 4 may be bound to several communication terminals. The communication terminal may detect regularly whether being in the used state or mobile state, and when detecting being in the used state or mobile state, switch the incoming call or message of the bound terminal of the communication terminal to the communication terminal, and furthermore, when detecting being not in the used state or mobile state, switch the incoming call or message of the communication terminal to the bound terminal in the used state or mobile state, such that an incoming call may be timely switched, and the waiting time for switching the incoming call may be shortened.

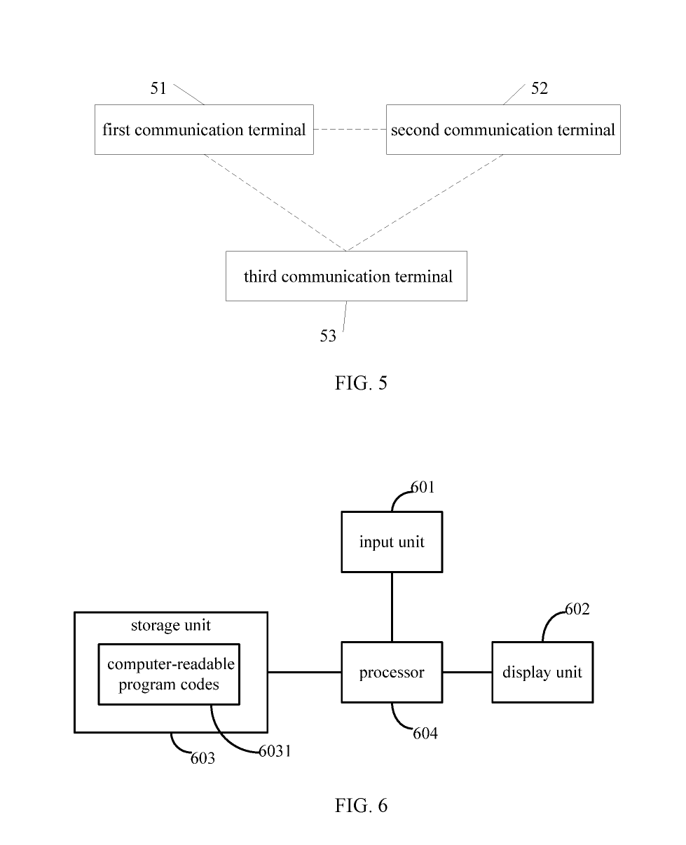

Referring to FIG. 5, it shows a schematic structural diagram of an incoming call switching system according to an embodiment of the present invention. In practice, a system according to embodiments of the present invention may include at least two communication terminals; however, for the convenience of explanation, three communication terminals are taken as an example. The incoming call switching system includes a first communication terminal 51, a second communication terminal 52 and a third communication terminal 53.

The first communication terminal 51, the second communication terminal 52, and the third communication terminal 53 may be, for example, a mobile terminal or fixed-line phone. The first communication terminal 51 is bound to the second communication terminal 52 and the third communication terminal 53. The first communication terminal 51 may be bound to communication numbers of the second communication terminal 52 and the third communication terminal 53. The communication numbers may be, for example, SIM card number.

The first communication terminal 51 may detect whether it is in a used state or mobile state, and when the first communication terminal 51 is detected being in the used state or mobile state, send an control instruction to a bound terminal of the first communication terminal 51 (i.e. the second communication terminal 52 and the third communication terminal 53) so as to switch an incoming call or message of the bound terminal to the first communication terminal 51. Specifically, the first communication terminal 51 judge whether it is being used by detecting whether an operation instruction given by a user to the first communication terminal 51 is received. For example, when operations such as tapping on the screen, waking up the screen, accessing network etc. occurs on the first communication terminal 51, it may be determined that the first communication terminal 51 is in the used state. Moreover, it may be judged whether the first communication terminal 51 is in the mobile state with a gravity accelerometer or GPS. For example, when the gravity accelerometer or GPS detects the position state of the first communication terminal 51 being always changing, it may be determined that the first communication terminal 51 is in the mobile state, on the contrary, it may be determined that the first communication terminal 51 is stationary, and is maybe forgotten somewhere. Of course, the mobile state of the first communication terminal 51 may also be detected with other sensors or positioning devices which can measure the mobile state. It is to be noted that the purpose of judging whether the first communication terminal 51 is in a used state or mobile state is to detect whether the first communication terminal 51 is by the user's side. It may also be detected whether the first communication terminal 51 is by the user's side by methods other than judging the used state or mobile state, for example, detecting whether the first communication terminal 51 touches the user with a touch sensor on the first communication terminal 51 (when the user sits stationarily with the first communication terminal 51 in a trousers pocket). when the first communication terminal 51 is detected being in the used state or mobile state, the incoming call or message of the second communication terminal 52 and the third communication terminal 53 which are bound to the first communication terminal 51 and are not in the used state or mobile state are switched to the first communication terminal 51. The specific implementing manner may be that, for example, the first communication terminal 51 sends an incoming call switching control instruction to the second communication terminal 52 and the third communication terminal 53 which are bound to the first communication terminal 51 and are not in the used state or mobile state, such that the second communication terminal 52 and the third communication terminal 53 switch the incoming call or message to the first communication terminal 51. In addition, the incoming call switching control instruction may be a message of specific format.

The first communication terminal 51 may receive the incoming call switching control instruction sent by the second communication terminal 52 or the third communication terminal 53 in the used state or mobile state when detecting it is not in the used state or mobile state (for example, the first communication terminal 51 is forgotten home), so as to switch the incoming call or message of the first communication terminal 51 to the second communication terminal 52 or the third communication terminal 53 in the used state or mobile state.

Furthermore, the first communication terminal 51, the second communication terminal 52, and the third communication terminal 53 may be the communication terminal 30 or the communication terminal 40 as shown in FIG. 3 or FIG. 4.

The incoming call switching system provided in FIG. 5 may bind several communication terminals together. The communication terminal may detect regularly whether being in the used state or mobile state, and when detecting being in the used state or mobile state, switch the incoming call or message of the bound terminal of the communication terminal to the communication terminal, and furthermore, when detecting being not in the used state or mobile state, switch the incoming call or message of the communication terminal to the bound terminal in the used state or mobile state, such that an incoming call may be timely switched, and the waiting time for switching the incoming call may be shortened.

Referring to FIG. 6, it is a schematic structural diagram of a communication terminal according to an embodiment of the present invention. The communication terminal can include but not limited to an input unit 601, a display unit 602, a storage unit 603, and a processor 604. The input unit 601, the display unit 602, and the storage unit 603 are electrically connected to the processor 604.

The input unit 601 is configured to input information to the terminal, such as letters. The input unit 601 may be but not limited to a physical keyboard, a touchscreen, or a combination of the physical keyboard and the touchscreen.

The display unit 602 is configured to display visual information, such as text, image. The display unit 602 may be an LED display screen.

The storage unit 603 is configured to store a plurality of computer-readable program codes 6031. The storage unit 603 can be a read only memory (ROM), a random access memory (RAM), a U-disk, a removable hard disk, etc.

The processor 604 can include multiple cores for multi-thread or parallel processing. In this embodiment, the processor 604 is configured to execute the plurality of computer-readable program codes 6031 to judge whether the communication terminal is an answering terminal; and send the control instruction to the bound terminal of the communication terminal so as to switch the incoming call or message of the bound terminal to the communication terminal and designate the communication terminal as the answering terminal, if the communication terminal is not the answering terminal.

In this embodiment, after detecting whether a communication terminal is in the used state or mobile state, the processor 604 is configured to execute the plurality of computer-readable program codes 6031 to judge whether the control instruction sent by the bound terminal in the used state or mobile state is received if the communication terminal is not in the used state or mobile state, and if the control instruction is received, switch the incoming call or message of the communication terminal to the bound terminal sending the control instruction and designate the communication terminal as a switching terminal.

In this embodiment, after detecting whether a communication terminal is in the used state or mobile state, the processor 604 is configured to execute the plurality of computer-readable program codes 6031 to judge whether the control instruction sent by the bound terminal in the used state or mobile state is received if the communication terminal is not in the used state or mobile state, and if the control instruction is received, switch the incoming call or message of the communication terminal to the bound terminal sending the control instruction and designate the communication terminal as a switching terminal.

In this embodiment, after designating the communication terminal as the switching terminal, the processor 604 is configured to execute the plurality of computer-readable program codes 6031 to switch the operating mode of the communication terminal into a power-saving mode.

In this embodiment, the processor 604 is configured to execute the plurality of computer-readable program codes 6031 to detect whether an operation instruction given by a user to the communication terminal is received, so as to judge whether the communication terminal is in the used state; or judge whether the communication terminal is in the mobile state with a gravity accelerometer; or judge whether the communication terminal is in the mobile state with GPS.

According to actual requirements, the steps in the methods of the embodiments of the present invention may be combined and deleted, and their sequence may be adjusted.

The modules or units in the apparatus of the embodiments of the present invention may be combined, divided, and deleted according to actual requirements.

The modules or units in the embodiments of the present invention may be implemented with a general integrated circuit (for example, CPU) or an ASIC (Application Specific Integrated Circuit).

Persons skilled in the art may understand that all or a part of the steps in the methods in the foregoing embodiments may be implemented by a program instructing relevant hardware. The program may be stored in a computer-readable storage medium. The storage medium may include a flash memory, a read-only memory (ROM), a random access memory (RAM), a magnetic disk, or an optical disc, and so on.

The incoming call switching method and the communication terminal provided by the embodiments of the present invention are described in detail hereinbefore. The principles and embodiments of the present invention are set forth by way of specific examples herein. The explanation of the above-mentioned embodiments is merely for assisting in understanding the methods and spirits of the present invention. Meanwhile, based on the concepts of the present invention, persons skilled in the art would make modifications to the embodiments and applying scope. In conclusion, the content of the present invention should not be considered as a limitation to the present invention.

What is claimed is:

1. An incoming call switching method, comprising:
detecting whether a communication terminal is in a used state or mobile state; and
sending a control instruction to a bound terminal of the communication terminal so as to switch an incoming call or message of the bound terminal to the communication terminal, if the communication terminal is in the used state or mobile state.

2. The method according to claim 1, wherein after the communication terminal is detected being in the used state or mobile state, the method comprises:
judging whether the communication terminal is an answering terminal; and
sending the control instruction to the bound terminal of the communication terminal so as to switch the incoming call or message of the bound terminal to the communication terminal and designating the communication terminal as the answering terminal, if the communication terminal is not the answering terminal.

3. The method according to claim 1, wherein after detecting whether a communication terminal is in the used state or mobile state, the method comprises:
judging whether the control instruction sent by the bound terminal in the used state or mobile state is received if the communication terminal is not in the used state or mobile state, and if the control instruction is received, switching the incoming call or message of the communication terminal to the bound terminal sending the control instruction and designating the communication terminal as a switching terminal.

4. The method according to claim 2, wherein after detecting whether a communication terminal is in the used state or mobile state, the method comprises:
judging whether the control instruction sent by the bound terminal in the used state or mobile state is received if the communication terminal is not in the used state or mobile state, and if the control instruction is received, switching the incoming call or message of the communication terminal to the bound terminal sending the control instruction and designating the communication terminal as a switching terminal.

5. The method according to claim 3, wherein after designating the communication terminal as the switching terminal, the method comprises:
switching the operating mode of the communication terminal into a power-saving mode.

6. The method according to claim 4, wherein after designating the communication terminal as the switching terminal, the method comprises:
switching the operating mode of the communication terminal into a power-saving mode.

7. The method according to claim 1, wherein detecting whether a communication terminal is in a used state or mobile state, comprises:
detecting whether an operation instruction given by a user to the communication terminal is received, so as to judge whether the communication terminal is in the used state; or
judging whether the communication terminal is in the mobile state with a gravity accelerometer; or
judging whether the communication terminal is in the mobile state with GPS.

8. A communication terminal, comprising:
a detecting unit for detecting whether the communication terminal is in a used state or mobile state; and
a first switching unit for, when the detecting unit detects the communication terminal being in the used state or mobile state, sending a control instruction to a bound terminal of the communication terminal so as to switch an incoming call or message of the bound terminal to the communication terminal.

9. The communication terminal according to claim 8, wherein the first switching unit comprises:
a answering state judging unit for judging whether the communication terminal is an answering terminal after the communication terminal is detected being in the used state or mobile state; and
a first switching unit for sending the control instruction to the bound terminal of the communication terminal when the answering state judging unit determines the communication terminal is not the answering terminal, switching the incoming call or message of the bound terminal to the communication terminal, and designating the communication terminal as the answering terminal.

10. The communication terminal according to claim 8, wherein the terminal further comprises:
a second switching unit for judging whether the control instruction sent by the bound terminal in the used state or mobile state is received if the communication terminal is not in the used state or mobile state after the detection unit detects whether the communication terminal is in the used state or mobile state;
if the control instruction is received, switching the incoming call or message of the communication terminal to the bound terminal sending the control instruction and designating the communication terminal as a switching terminal.

11. The communication terminal according to claim 9, wherein the terminal further comprises:
a second switching unit for judging whether the control instruction sent by the bound terminal in the used state or mobile state is received if the communication terminal is not in the used state or mobile state after the detection unit detects whether the communication terminal is in the used state or mobile state;
if the control instruction is received, switching the incoming call or message of the communication terminal to the bound terminal sending the control instruction and designating the communication terminal as a switching terminal.

12. The communication terminal according to claim 10, wherein the terminal further comprises:
a switching unit for switching the operating mode of the communication terminal into a power-saving mode after the communication terminal is designated as the switching terminal.

13. The communication terminal according to claim 8, wherein the detection unit comprises:
a used state detecting unit for detecting whether an operation instruction given by a user to the communication terminal is received, so as to judge whether the communication terminal is in the used state;
a mobile state detecting unit for judging whether the communication terminal is in the mobile state with a gravity accelerometer or judging whether the communication terminal is in the mobile state with GPS.

14. A communication terminal comprising:
a storage unit storing a plurality of computer-readable program codes; and
a processor electrically connected to the storage unit and configured to execute the plurality of computer-readable program codes to:
detect whether a communication terminal is in a used state or mobile state; and
send a control instruction to a bound terminal of the communication terminal so as to switch an incoming call or message of the bound terminal to the communication terminal,
if the communication terminal is in the used state or mobile state.

15. The communication terminal according to claim 14, wherein after the communication terminal is detected being in the used state or mobile state, the processor is configured to execute the plurality of computer-readable program codes to:
judge whether the communication terminal is an answering terminal; and
send the control instruction to the bound terminal of the communication terminal so as to switch the incoming call or message of the bound terminal to the communication terminal and designate the communication terminal as the answering terminal, if the communication terminal is not the answering terminal.

16. The communication terminal according to claim 14, wherein after detecting whether a communication terminal is in the used state or mobile state, the processor is configured to execute the plurality of computer-readable program codes to:
judge whether the control instruction sent by the bound terminal in the used state or mobile state is received if the communication terminal is not in the used state or mobile state, and if the control instruction is received, switch the incoming call or message of the communication terminal to the bound terminal sending the control instruction and designate the communication terminal as a switching terminal.

17. The communication terminal according to claim 15, wherein after detecting whether a communication terminal is in the used state or mobile state, the processor is configured to execute the plurality of computer-readable program codes to:
judge whether the control instruction sent by the bound terminal in the used state or mobile state is received if the communication terminal is not in the used state or mobile state, and if the control instruction is received, switch the incoming call or message of the communication terminal to the bound terminal sending the control instruction and designate the communication terminal as a switching terminal.

18. The communication terminal according to claim 16, wherein after designating the communication terminal as the switching terminal, the processor is configured to execute the plurality of computer-readable program codes to:
switch the operating mode of the communication terminal into a power-saving mode.

19. The communication terminal according to claim 17, wherein after designating the communication terminal as the switching terminal, the processor is configured to execute the plurality of computer-readable program codes to:
switch the operating mode of the communication terminal into a power-saving mode.

20. The communication terminal according to claim 14, wherein the processor being configured to execute the plurality of computer-readable program codes to detect whether a communication terminal is in a used state or mobile state, comprises:
detecting whether an operation instruction given by a user to the communication terminal is received, so as to judge whether the communication terminal is in the used state; or
judging whether the communication terminal is in the mobile state with a gravity accelerometer; or
judging whether the communication terminal is in the mobile state with GPS.
